(19) United States
(12) Patent Application Publication
(10) Pub. No.: US 2025/0189288 A1
(43) Pub. Date: Jun. 12, 2025

(54) METHOD AND COORDINATE MEASURING MACHINE

(71) Applicant: Klingelnberg GmbH, Hückeswagen (DE)

(72) Inventor: Benjamin Merkert, Wipperfürth (DE)

(21) Appl. No.: 18/972,108

(22) Filed: Dec. 6, 2024

(30) Foreign Application Priority Data
Dec. 8, 2023 (DE) 10 2023 134 503.6

(51) Int. Cl. G01B 5/008; G01B 5/00; G01B 11/00; G01H 13/00

(52) U.S. Cl. CPC G01B 5/008; G01B 5/0004; G01H 13/00; G01B 11/005

(57) ABSTRACT

A method for coordinate measuring includes the following steps: moving a measuring probe of a coordinate measuring machine by moving at least one machine axis of the coordinate measuring machine assigned to the measuring probe; characterized by monitoring a vibration behavior of the measuring probe during the movement of the measuring probe, wherein a vibration excitation in the direction of at least one measuring probe axis of the measuring probe is detected and compared with an axis-specific natural frequency of the measuring probe in the direction of the at least one measuring probe axis; adaptation of a dynamic influence factor which has an influence on the vibration behavior of the measuring probe, such as a measuring speed, a mass of the measuring probe or the like, provided that the vibration excitation is detected in the range of the axis-specific natural frequency.

### CROSS-REFERENCE TO RELATED APPLICATIONS

This application claims the benefit of German patent application no. 10 2023 134 503.6, filed on 8 Dec. 2023, the disclosure of which is incorporated herein by reference in its entirety.

### TECHNICAL FIELD

The present disclosure relates to a method comprising moving a measuring probe of a coordinate measuring machine by moving at least one machine axis of the coordinate measuring machine assigned to the measuring probe. The disclosure further relates to a coordinate measuring machine for carrying out such a method.

### BACKGROUND

Measuring probes for tactile coordinate measurement can be excited to vibrate in the range of their natural frequencies during the measurement. In particular during tactile gear measurement, these natural frequencies can be in the vicinity of the tooth flank waviness to be measured, e.g. in the range of 6 Hz, wherein the measurement result can be impaired by vibration excitation of the measuring probe. As a result, it may not be possible to recognize what proportion of a measured waviness results from a vibration excitation of the measuring probe and what proportion of the measured waviness reflects the actual waviness of the surface of a tooth flank.

### SUMMARY

Against this background, the present disclosure is based on the technical problem of specifying a method that enables reliable tactile measurement. Furthermore, a coordinate measuring machine for carrying out such a method is to be specified.

The technical problem described above is solved in each case with the features of the independent claims. Further designs of the disclosure result from the dependent claims and the following description.

According to a first aspect, the disclosure relates to a method comprising the method steps of: moving a measuring probe of a coordinate measuring machine by moving at least one machine axis of the coordinate measuring machine assigned to the measuring probe; monitoring a vibration behavior of the measuring probe during the movement of the measuring probe, wherein a vibration excitation in the direction of at least one measuring probe axis of the measuring probe is detected and compared with an axis-specific natural frequency in the direction of the at least one measuring probe axis; and adaptation of a dynamic influence factor which has an influence on the vibration behavior of the measuring probe, such as a measuring speed, a mass of the measuring probe or the like, provided that the vibration excitation is detected in the range of the axis-specific natural frequency.

In particular, it is therefore possible to detect whether a critical excitation of the probe occurs during a measurement, which could result in a falsification of a measurement result. Conversely, it can be detected in particular that no critical excitation of the probe occurs during a measurement and therefore the measurement results have not been falsified as a result of excitation of the probe.

If a possible falsification of a measurement result is detected, the measurement can be repeated in particular, e.g. with adapted dynamic conditions, in which travel speeds and/or travel accelerations are adapted, or weight is added to the probe or a stylus and/or a probe ball of a different mass is used.

To adjust the dynamic conditions or to adjust a dynamic influence factor, damping in the direction of the corresponding probe axis can be used.

Alternatively, the dynamic conditions can be adapted by changing a pretension in the direction of the measuring probe axes and/or the measuring probe suspensions.

According to one design of the method, it may be provided that a reference run for measuring the axis-specific natural frequency in the direction of the at least one measuring probe axis is carried out before the measuring probe is moved, wherein the measuring probe is set into vibration by acceleration and braking, in particular jerky braking, and the vibration is evaluated by means of a frequency analysis, in particular that the measuring probe vibrates freely during the reference run and does not rest against an object to be measured or the like.

It may be provided that the monitoring of the vibration behavior of the measuring probe comprises a continuous axis-specific FFT analysis of a measurement signal of the at least one measuring probe axis. In particular, the FFT analysis is performed continuously during the movement of the measuring probe, i.e. in particular during an entire measurement cycle. Alternatively, it may be provided that the FFT analysis is only carried out when the probe is in contact with an object to be measured or is in tactile measuring contact.

According to one design of the method, it may be provided that the measuring probe is assigned three orthogonal measuring probe axes for detecting measured values in three orthogonal spatial directions, wherein the measuring probe has an axis-specific natural frequency in the direction of each of the three measuring probe axes, which natural frequency is compared with the vibration excitation during the movement of the measuring probe while the vibration behavior of the measuring probe is being monitored, wherein an adjustment of the dynamic influence factor or several dynamic influence factors takes place if a vibration excitation in the range of the axis-specific natural frequency is detected for the measuring probe in the direction of at least one of the measuring probe axes, in particular that the measuring probe has three orthogonal parallelogram suspensions.

Three-dimensional measuring probes with orthogonal parallelogram suspensions are known, for example, from documents DE 197 21 015 C1 and EP 1 589 317 B1.

It may be provided that a reference run is carried out for measuring the axis-specific natural frequency for each of the probe axes before moving the probe. If the measuring probe is a measuring probe that measures in three dimensions, a reference run can therefore be carried out in each of the three orthogonal spatial directions in order to determine the axis-specific natural frequencies.

According to one design of the method, it may be provided that the movement of the measuring probe comprises a tactile measurement of a component to be measured, wherein the measuring probe detects measured values in a tactile manner in contact with the component to be measured, wherein the component to be measured comprises in particular a gearing which is measured in a tactile manner by means of the measuring probe.

It may be provided that the coordinate measuring machine comprises a rotary table for accommodating the component to be measured in order to rotate the component to be measured about an axis of rotation of the component, wherein measuring movements of the coordinate measuring machine comprise an at least partial rotation of the component to be measured about its own axis.

According to one design of the method, it may be provided that the coordinate measuring machine issues a warning if the vibration excitation is detected in the range of the axis-specific natural frequency of the measuring probe. As a result of the warning, an operator can repeat the measurement with adapted dynamic conditions in order to rule out any influence of the vibration excitation on the measurement result.

According to a second aspect, the disclosure relates to a coordinate measuring machine having a measuring probe, having at least one machine axis assigned to the measuring probe and having a control system which is set up to carry out the method according to the disclosure.

It may be provided that the coordinate measuring machine is a gear measuring machine which has a rotary table for rotating a gearing to be measured about its axis of rotation.

### BRIEF DESCRIPTION OF THE DRAWINGS

The disclosure is explained in more detail below with reference to drawings illustrating exemplary embodiments, which show schematically in each case:

FIG. 1 shows a coordinate measuring machine according to the disclosure;

FIG. 2 shows a measuring probe system with a measuring probe; and

FIG. 3 shows a flow chart of a method according to the disclosure.

### DETAILED DESCRIPTION OF THE DRAWINGS

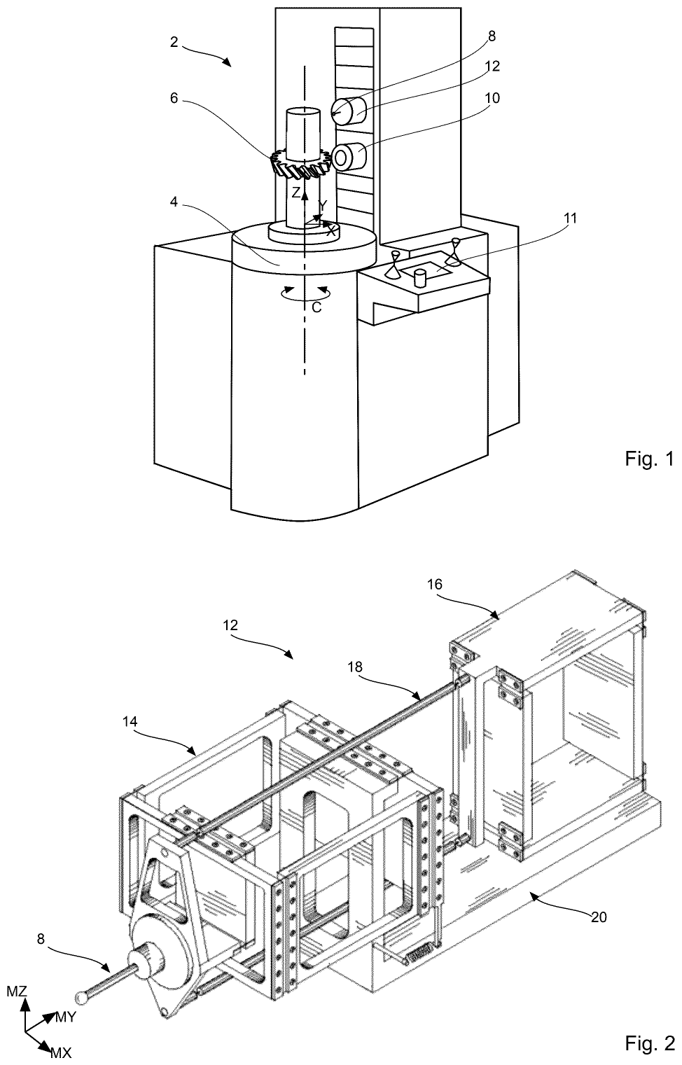

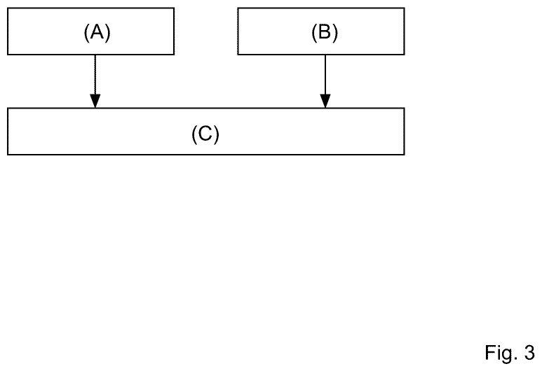

FIG. 1 shows a coordinate measuring machine 2 according to the disclosure. The coordinate measuring machine 2 is a gear measuring machine. The coordinate measuring machine 2 has a rotary table 4, which is provided for accommodating and rotating a component 6 to be measured about its own axis. In this case, the component 6 to be measured is a gearwheel.

The coordinate measuring machine 2 has a measuring probe 8 for tactile gear measurement, which is held on a measuring probe 12. The coordinate measuring machine 2 also has an optical measuring device 10 for optical gear measurement. The coordinate measuring machine 2 has a control system 11 which is set up to carry out a method according to the disclosure described below.

The measuring probe 8 can be moved in three mutually orthogonal spatial directions X, Y, Z by means of controlled machine axes of the coordinate measuring machine. The reference signs X, Y and Z therefore denote equally controlled numerical axes of the coordinate measuring machine 2, which enable the probe 8 to be moved in the X, Y and Z directions according to the degrees of freedom mentioned. Rotation about the C axis by means of the rotary table 4 represents a further degree of freedom of movement for carrying out measuring movements.

FIG. 2 shows a schematic example of the measuring probe 12 on which the measuring probe 8 is held. In particular, the measuring probe 8 can be detachably and interchangeably attached to the measuring probe system 12, for example by means of a magnetic attachment. The measuring probe system 12 has three parallelogram suspensions 14, 16, 18, which enable mutually orthogonal movements of the measuring probe 8 in the MX direction, MY direction and MZ direction. The structure and mode of operation of such a three-dimensional measuring probe system 12 are sufficiently known, in particular from documents DE 197 21 015 C1 and EP 1 589 317 B1, the disclosure of which in this regard is incorporated by reference into the disclosure of the present application.

The MX, MY and MZ axes are also referred to as measuring probe axes.

In a first method step (A) of the method according to the disclosure, the measuring probe 8 of the coordinate measuring machine 2 is first moved, in which at least one machine axis X, Y, Z of the coordinate measuring machine 2 assigned to the measuring probe 8 is moved. Moving the measuring probe 8 also means moving the entire measuring probe system 12, since the measuring probe 8 is held on this measuring probe system 12 and the measuring probe system 12 is held on the movable machine axes X, Y, Z of the coordinate measuring machine 2 via a base plate 20.

The movement of the measuring probe 8 can comprise measuring movements for carrying out a gear measurement, wherein the measuring movements comprise both movements in contact with the component 6 to be measured and movements that do not take place in contact with the component 6 to be measured.

During the movement of the measuring probe 8, in a method step (B), which thus takes place simultaneously with method step (A), a monitoring of a vibration behavior of the measuring probe 8 is carried out, wherein a vibration excitation in the direction of each of the three measuring probe axes MX, MY, MZ is detected and compared with an axis-specific natural frequency of the measuring probe 8 in the direction of the respective measuring probe axis MX, MY, MZ.

If a vibration excitation is detected for the measuring probe in the direction of one of the measuring probe axes MX, MY, MZ in the range of the respective axis-specific natural frequency, a dynamic influence factor is adapted in a method step (C), which has an influence on the vibration behavior of the measuring probe 8.

An adjustment of the dynamic influence factor can, for example, be a change in the speed of the machine axes of the coordinate measuring machine 2 during the execution of the measuring movements or the movement of the measuring probe. The adjustment of the dynamic influence factor can, for example, mean an adjustment of a damping in the direction of the relevant probe axis. A pretension of a suspension of the parallelograms can also be changed. Furthermore, a mass of the measuring probe 8 can be changed by replacing components of the measuring probe, such as a probe ball, a stylus or the like.

It may be provided that a reference run is performed to measure the axis-specific natural frequency of the measuring probe 8 in the direction of each of the measuring probe axes MX, MY, MX before the measuring probe 8 is moved.

For a respective reference run, it may be provided that the measuring probe 8 is accelerated and decelerated in the corresponding spatial directions, in particular decelerated jerkily, in order to set the measuring probe 8 into vibration, and this vibration is evaluated by means of a frequency analysis. During a respective reference run, the measuring probe can oscillate freely and is not in contact with an object to be measured or the like.

The monitoring of the vibration behavior of the measuring probe 8 according to method step (B) can have a continuous axis-specific FFT analysis of a measurement signal for each of the measuring probe axes MX, MY, MX. Therefore, during the movement of the probe 8, i.e. in particular during a measurement process, it is continuously checked for each of the probe axes MX, MY, MX whether a vibration excitation of the probe 8 occurs in the range of one of the natural frequencies.

1. A method includes the following steps:
moving a measuring probe of a coordinate measuring machine by moving at least one machine axis of the coordinate measuring machine assigned to the measuring probe; whereby
monitoring of a vibration behavior of the measuring probe during the movement of the measuring probe, wherein a vibration excitation in the direction of at least one measuring probe axis of the measuring probe is detected and compared with an axis-specific natural frequency of the measuring probe in the direction of the at least one measuring probe axis; and
adaptation of a dynamic influence factor which has an influence on the vibration behavior of the measuring probe, such as a measuring speed, a mass of the measuring probe or the like, provided that the vibration excitation is detected in the range of the axis-specific natural frequency.

2. The method according to claim 1,
wherein a reference run for measuring the axis-specific natural frequency in the direction of the at least one measuring probe axis is carried out before the measuring probe is moved, wherein the measuring probe is set into vibration by acceleration and braking, and the vibration is evaluated by a frequency analysis, wherein the measuring probe vibrates freely during the reference run and does not rest against an object to be measured or the like.

3. The method according to claim 1,
wherein the monitoring of the vibration behavior of the measuring probe comprises a continuous axis-specific FFT analysis of a measurement signal in the direction of the at least one measuring probe axis.

4. The method according to claim 1,
wherein the measuring probe is assigned three orthogonal measuring probe axes for detecting measured values in three orthogonal spatial directions, wherein the measuring probe has an axis-specific natural frequency in the direction of each of the three measuring probe axes, which natural frequency is compared with the vibration excitation during the movement of the measuring probe while the vibration behavior of the measuring probe is being monitored, wherein an adjustment of the dynamic influence factor or several dynamic influence factors takes place if a vibration excitation in the range of the axis-specific natural frequency is detected for the measuring probe in the direction of at least one of the measuring probe axes, wherein the measuring probe has three orthogonal parallelogram suspensions.

5. The method according to claim 4,
wherein a reference run for measuring the axis-specific natural frequency is carried out for each of the probe axes before moving the probe.

6. The method according to claim 1,
wherein the movement of the measuring probe comprises a tactile measurement of a component to be measured, wherein the measuring probe detects measured values in a tactile manner in contact with the component to be measured, wherein the component to be measured comprises a gearing which is measured in a tactile manner by the measuring probe.

7. The method according to claim 6,
wherein the coordinate measuring machine comprises a rotary table for accommodating the component to be measured in order to rotate the component to be measured about an axis of rotation of the component, wherein measuring movements of the coordinate measuring machine comprise an at least partial rotation of the component to be measured about its own axis.

8. The method according to claim 1,
wherein the coordinate measuring machine issues a warning if the vibration excitation is detected in the range of the axis-specific natural frequency of the measuring probe.

9. A coordinate measuring machine comprising:
a measuring probe;
at least one machine axis assigned to the probe; and
a control system set up to carry out the method according to claim 1.

10. The coordinate measuring machine according to claim 9,
wherein the coordinate measuring machine is a gear measuring machine which has a rotary table for rotating a gearing to be measured about an axis of rotation.
